(19) United States
(12) Patent Application Publication
(10) Pub. No.: US 2026/0205606 A1
(43) Pub. Date: Jul. 16, 2026

(54) METHOD FOR ENCODING VIDEO, ELECTRONIC DEVICE AND STORAGE MEDIUM

(71) Applicant: Beijing Baidu Netcom Science Technology Co., Ltd., Beijing (CN)

(72) Inventor: Jiaojiao ZHANG, Beijing (CN)

(21) Appl. No.: 19/559,519

(22) Filed: Mar. 6, 2026

(30) Foreign Application Priority Data
Aug. 6, 2025 (CN) 202511102517.6

(51) Int. Cl. H04N 19/167; G06V 10/44; G06V 20/40; G06V 40/16; H04N 19/105; H04N 19/172; H04N 19/196; H04N 19/513; H04N 19/543; H04N 19/553

(52) U.S. Cl. CPC H04N 19/167; G06V 10/443; G06V 20/46; G06V 40/165; G06V 40/171; H04N 19/105; H04N 19/172; H04N 19/196; H04N 19/521; H04N 19/543; H04N 19/553

(57) ABSTRACT

Provided is a method for encoding a video, an electronic device and a storage medium, relating to the field of video encoding. The method includes: obtaining a reference frame that is adjacent to a current frame and has established hierarchical division of an initial ROI; reusing a motion vector generated by the reference frame in a motion compensated temporal filter process to determine an ROI position prediction value of the current frame; extracting facial feature points from the current frame, and correcting the ROI position prediction value based on a spatial topological relationship of feature points in the initial ROI; configuring differentiated quantization parameters for a main face region, a secondary face region and a background region after correction respectively; dynamically allocating a three-region bitrate according to a real-time network bandwidth; and outputting an encoded frame of the current frame and associated ROI-level metadata.

### CROSS-REFERENCE TO RELATED APPLICATIONS

The present application claims priority to Chinese Patent Application No. CN202511102517.6, filed with the China National Intellectual Property Administration on Aug. 6, 2025, the disclosure of which is hereby incorporated herein by reference in its entirety.

### TECHNICAL FIELD

The present disclosure relates to the field of image processing technology and in particular to the field of video encoding, and can be used in application scenarios such as live video streaming, and specifically relates to a method and an apparatus for encoding a video, an electronic device and a storage medium.

### BACKGROUND

In the field of live streaming technology, in order to improve the viewing experience of audiences, the Region of Interest (ROI) in the live video is usually encoded and optimized with emphasis to ensure the high-quality presentation of key content under the limited bitrate. However, the existing ROI encoding technologies have problems of insufficient real-time performance, large resource consumption and coarse bitrate allocation, and fail to effectively meet the high efficiency and high-quality requirements under live streaming scenarios.

### SUMMARY

The present disclosure provides a method and an apparatus for encoding a video, an electronic device and a storage medium.

According to a first aspect of the present disclosure, provided is a method for encoding a video, including: obtaining a reference frame that is adjacent to a current frame and has established hierarchical division of an initial ROI; reusing a motion vector generated by the reference frame in a motion compensated temporal filter process to determine an ROI position prediction value of the current frame; extracting facial feature points from the current frame, and correcting the ROI position prediction value based on a spatial topological relationship of feature points in the initial ROI; configuring differentiated quantization parameters for a main face region, a secondary face region and a background region after correction respectively; dynamically allocating a three-region bitrate according to a real-time network bandwidth; and outputting an encoded frame of the current frame and associated ROI-level metadata; where the ROI-level metadata includes: boundary coordinates of the main face region, the secondary face region and the background region; offset values of quantization parameters corresponding to all regions; and bitrate allocation weight values of all regions.

According to a second aspect of the present disclosure, provided is an apparatus for encoding a video, including: a reference frame obtaining module configured to obtain a reference frame that is adjacent to a current frame and has established hierarchical division of an initial ROI; a position prediction module configured to reuse a motion vector generated by the reference frame in a motion compensated temporal filter process to determine an ROI position prediction value of the current frame; a position correction module configured to extract facial feature points from the current frame, and correct the ROI position prediction value based on a spatial topological relationship of feature points in the initial ROI; a parameter configuration module configured to configure differentiated quantization parameters for a main face region, a secondary face region and a background region after correction respectively; a bitrate allocation module configured to dynamically allocate a three-region bitrate according to a real-time network bandwidth; and a data output module configured to output an encoded frame of the current frame and associated ROI-level metadata; where the ROI-level metadata includes: boundary coordinates of the main face region, the secondary face region and the background region; offset values of quantization parameters corresponding to all regions; and bitrate allocation weight values of all regions.

According to a third aspect of the present disclosure, provided is an electronic device, including: at least one processor; and a memory connected in communication with the at least one processor; where the memory stores an instruction executable by the at least one processor, and the instruction is executed by the at least one processor to enable the at least one processor to execute the method according to any one of the embodiments of the present disclosure.

According to a fourth aspect of the present disclosure, provided is a non-transitory computer-readable storage medium storing a computer instruction thereon, and the computer instruction is used to cause a computer to execute the method according to any one of the embodiments of the present disclosure.

According to a fifth aspect of the present disclosure, provided is a computer program product including a computer program, and the computer program implements the method according to any one of the embodiments of the present disclosure, when executed by a processor.

The solution of the present disclosure eliminates the overhead of independent motion estimation by reusing the motion vector generated in the motion compensated temporal filter process; achieves cross-frame tracking through the ROI position prediction based on the motion vector; extracts feature points and establishes the spatial topological relationship in the first frame as a correction benchmark; reuses the topological relationship to correct the predicted ROI position in subsequent frames, to ensure the positioning accuracy; and improves the encoding efficiency and quality by combining differentiated quantization parameters and dynamically adapting to the network environment.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure.

FIG. 1 is a schematic flow chart of a method for encoding a video according to an embodiment of the present disclosure;

FIG. 2 is another schematic flow chart of a method for encoding a video according to an embodiment of the present disclosure;

FIG. 3 is a structural schematic diagram of an apparatus for encoding a video according to an embodiment of the present disclosure;

FIG. 4 is a schematic diagram of a scenario of the method for encoding the video according to an embodiment of the present disclosure; and

FIG. 5 is a structural diagram of an electronic device for implementing the method for encoding the video in the embodiments of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope of the present disclosure. Likewise, for clarity and conciseness, descriptions of well-known functions and structures are omitted in the following descriptions.

The term “and/or” herein only describes an association relation of associated objects, which indicates that there may be three kinds of relations, for example, A and/or B may indicate that only A exists, or both A and B exist, or only B exists. The term “at least one” herein indicates any one of many items, or any combination of at least two of the many items, for example, at least one of A, B or C may indicate any one or more elements selected from a set of A, B and C. The terms “first” and “second” herein indicate a plurality of similar technical terms and distinguish them from each other, but do not limit an order of them or limit that there are only two items, for example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should understand that the present disclosure may be performed without certain specific details. In some examples, methods, means, elements and circuits well known to those having ordinary skill in the art are not described in detail, in order to highlight the subject matter of the present disclosure.

Before the technical solutions of the embodiments of the present disclosure are introduced, the technical terms that may be used in the present disclosure are further explained:

Video encoding refers to the process of compressing and encoding the video data. The goal is to reduce the volume of the video data while maintaining the video quality as much as possible. This technology achieves the goal of efficient storage and transmission by removing the redundant information such as temporal redundancy, spatial redundancy and statistical redundancy from videos.

In the live streaming technology, in order to improve the viewing experience of audiences, the ROI encoding optimization technology is usually used to focus on encoding the anchor's face or key operation regions. However, the existing technologies have significant drawbacks: insufficient real-time performance, where complex deep learning algorithms take a long time to detect, resulting in increased encoding latency and live streaming stuttering; large resource consumption that is difficult for mobile devices to handle and requires reliance on cloud servers, further increasing the network transmission latency; and coarse bitrate allocation, simply distinguishing the ROI from background without fine-tuning key parts (such as facial features) within the ROI. In addition, the frame extraction detection strategy ignores scene dynamic characteristics, and the problem of mismatch of encoding resources is prone to occur during scene switching, resulting in wasted bitrate and reduced quality in key regions.

In order to at least partially solve one or more of the above problems and other potential problems, the present disclosure proposes a method for encoding a video. This method eliminates redundant calculations by reusing the motion vector of motion compensated temporal filter, significantly reducing the processing latency of the motion tracking module; and avoids independent motion estimation operations, achieving ROI cross-frame tracking with near-zero overhead and thus improving the real-time performance of encoding. The spatial consistency of feature points is maintained by a cross-frame reuse mechanism of the first frame topological relationship; the quality fluctuations of feature points reconstructed frame by frame are eliminated, ensuring clarity of details in key regions and thus optimizing the encoding quality; the quality and smoothness are intelligently balanced when the bandwidth fluctuates in combination with hierarchical encoding and dynamic bitrate allocation, enhancing the bandwidth adaptability; and the risk of live streaming stuttering is reduced by coordinating the optimization of motion tracking and bitrate control. Under the premise of ensuring the visual quality of the main face region, the optimization of overall bitrate efficiency is achieved and a three-in-one low-latency high-definition encoding framework of “tracking-grading-flow control” is established.

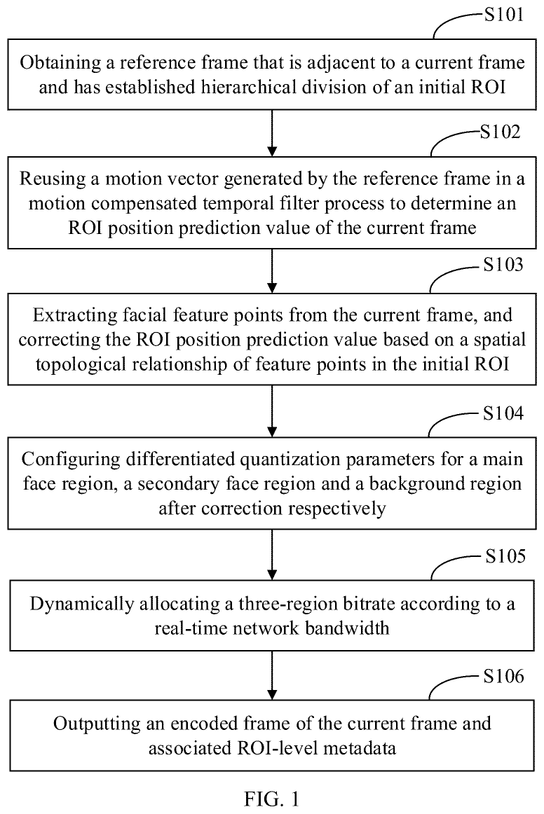

An embodiment of the present disclosure provides a method for encoding a video. FIG. 1 is a schematic flow chart of the method for encoding the video according to the embodiment of the present disclosure. This method for encoding the video may be applied to an apparatus for encoding a video. The apparatus for encoding the video is located in an electronic device. This electronic device includes but is not limited to a fixed device and/or a mobile device. For example, the fixed device includes but is not limited to a server, and the server may be a cloud server or an ordinary server. For example, the mobile device includes, but is not limited to, a video streaming device, which may be a mobile phone, a tablet, a vehicle-carried terminal, etc. In some possible implementations, the method for encoding the video may also be implemented by the processor calling a computer-readable instruction stored in the memory. As shown in FIG. 1, the method for encoding the video includes:
S101: obtaining a reference frame that is adjacent to a current frame and has established hierarchical division of an initial ROI;
S102: reusing a motion vector generated by the reference frame in a motion compensated temporal filter process to determine an ROI position prediction value of the current frame;
S103: extracting facial feature points from the current frame, and correcting the ROI position prediction value based on a spatial topological relationship of feature points in the initial ROI;
S104: configuring differentiated quantization parameters for a main face region, a secondary face region and a background region after correction respectively;
S105: dynamically allocating a three-region bitrate according to a real-time network bandwidth; and
S106: outputting an encoded frame of the current frame and associated ROI-level metadata.

Here, the current frame refers to a frame to be encoded currently in the video sequence. In the embodiment of the present disclosure, the video to be encoded consists of a series of consecutive image frames. In particular, the information of previous and next frames can be referenced when the current frame is processed.

Here, the ROI refers to a specific region or object of particular attention in image processing and computer vision. In the embodiment of the present disclosure, the ROI may be a region to be encoded with emphasis in the video frame. Exemplarily, the ROI may be a face region.

In the embodiment of the present disclosure, the reference frame adjacent to the current frame may be extracted from the obtained video sequence. Exemplarily, the reference frame may be a frame preceding or following the current frame in time; and at the same time, the reference frame may also be the N-th frame preceding the current frame in time, where N≥1 and N is a positive integer; similarly, the reference frame may also be the M-th frame following the current frame in time, where M≥1 and M is a positive integer; similarly, the reference frame may also be a keyframe selected by inter-frame prediction. In particular, the reference frame may also be determined by other methods in the prior art, and is not limited in the present disclosure. Further, the hierarchy of the partitioned main face region, secondary face region and background region may be obtained based on the determined reference frame, and then the boundary information of these regions may be recorded. The above is only an exemplary description and is not intended to limit all possible cases of obtaining the reference frame, but it is not exhaustive here.

Here, the Motion Compensated Temporal Filter (MCTF) is a method that uses inter-frame information in the time dimension for prediction and compensation. In the embodiment of the present disclosure, the MCTF can predict the pixel value of the current frame by analyzing the motion trend of pixels between consecutive frames, thereby reducing the temporal redundancy in the video.

Here, the Motion Vector (MV) can describe the motion trajectory of a pixel block between consecutive frames. In the embodiment of the present disclosure, the MV can be used to indicate the displacement of the target from the reference frame to the current frame.

Here, the ROI position prediction value refers to the estimation of the specific position of the ROI in the current frame based on the MV.

In the embodiment of the present disclosure, the motion vector generated by the MCTF process in the reference frame can be extracted first, and then the ROI position in the reference frame can be mapped to the current frame using the MV, and the predicted ROI position can be determined by translation, scaling and other operations. The above is only an exemplary description and is not intended to limit all possible cases of determining the ROI position prediction value of the current frame, but it is not exhaustive here.

Here, the facial feature points refer to key points in the face region, such as contour points of the eyes, nose and mouth. In the embodiment of the present disclosure, the facial feature points may be automatically extracted by a face detection algorithm.

Here, the spatial topological relationship of feature points can describe the positional relationship between feature points. In the embodiment of the present disclosure, the spatial topological relationship of feature points can describe the relative positions between facial feature points (for example, the relative positions between the eyes and the nose).

In the embodiment of the present disclosure, a deep learning model or a specific face detector may be used first to extract the facial feature points of the current frame. Subsequently, the predicted ROI value may be adjusted based on the positions of the feature points and the position of the ROI in the reference frame. The above is only an exemplary description and is not intended to limit all possible cases of correcting the ROI position prediction value, but it is not exhaustive here.

Here, the main face region refers to a region containing key feature points among the facial feature points in the ROI. Exemplarily, the key feature points may include eyes, nose, mouth, etc. In particular, the key feature points may be divided according to the actual situation, and are not limited in the present disclosure.

Here, the secondary face region refers to a region containing edge feature points among the facial feature points in the ROI, excluding the main face region. Exemplarily, the edge feature points may include cheeks and chin, etc. In particular, the edge feature points may be divided according to the actual situation, and are not limited in the present disclosure.

Here, the background region refers to a region other than the main face region and the secondary face region in the ROI.

Here, the quantization parameter refers to a parameter for controlling the encoding quality. In the embodiment of the present disclosure, the smaller the quantization parameter, the higher the bitrate, the higher the quality, and the larger the file.

In the embodiment of the present disclosure, different quantization parameters may be assigned to the main face region, the secondary face region and the background region according to the ROI division result, thereby reducing the resource consumption of the background region. In particular, the minimum quantization parameter may be assigned to the main face region, the medium quantization parameter may be assigned to the secondary face region, and the maximum quantization parameter may be assigned to the background region. The above is only an exemplary description and is not intended to limit all possible cases of configuring differentiated quantization parameters, but it is not exhaustive here.

Exemplarily, during the three-region partitioning, the spatial topological relationship of feature points may be established simultaneously. Specifically, the process of establishing the spatial topological relationship of feature points may be as follows: firstly, establishing a local rectangular coordinate system with the top-left vertex of the initial ROI region as the spatial origin; then converting the absolute image coordinates of all feature points into normalized coordinates relative to the initial ROI; and finally generating a spatial topological structure record of key points based on the normalized coordinate values. The topological structure record contains the normalized coordinate values of all feature points and the description of a relative positional relationship between any two feature points.

Exemplarily, the process of converting the absolute image coordinates of all feature points into normalized coordinates relative to the initial ROI may be represented by the following formula:

$${x}_{Normalization} = \frac{( {x}_{j} - {L}_{ROI , L} )}{{W}_{ROI}}$$

$${y}_{Normalization} = \frac{( {y}_{j} - {L}_{ROI , U} )}{{H}_{ROI}}$$

In the formula, x_{Normalization} represents a horizontal normalized coordinate; y_{Normalization} represents a vertical normalized coordinate; xⱼ represents the abscissa of the j-th feature point; yⱼ represents the ordinate of the j-th feature point; L_{ROI,L} represents the left boundary of the ROI; L_{ROI,U} represents the upper boundary of the ROI; W_{ROI} represents the width of the ROI; and H_{ROI} represents the height of the ROI.

Here, the network bandwidth refers to the maximum amount of data that a certain communication channel or network can transmit within a specific time period, and may be measured in bits per second. In the embodiment of the present disclosure, the network bandwidth can represent the network's ability to transmit data. The larger the bandwidth, the more data can be transmitted per unit of time, and the higher the network's transmission efficiency.

Here, the bitrate refers to the amount of data transmitted per unit of time, usually measured in kilobits per second. In the embodiment of the present disclosure, the bitrate can represent the amount of data transmitted per unit of time. The higher the bitrate, the larger the amount of data transmitted, and the higher the video quality. In particular, the bitrate affects the video quality and transmission speed.

In the embodiment of the present disclosure, the bitrate allocation of the main face, secondary face and background regions may be dynamically adjusted according to the current network bandwidth to ensure the user experience. The above is only an exemplary description and is not intended to limit all possible cases of allocating the three-region bitrate, but it is not exhaustive here.

Here, the encoded frame is a compressed image frame generated in the video encoding process, and the core function of the image frame is to convert the original video data into a smaller format easier to store and transmit while maintaining the visual quality of the original video as possible.

Here, the metadata is additional information associated with the encoded frame; describes the structure, characteristics or content of the encoded frame; and provides guidance information for the decoder or subsequent processing.

In the embodiment of the present disclosure, the ROI information may be added to the metadata after encoding the current frame, for easy use in decoding. The above is only an exemplary description and is not intended to limit all possible cases of outputting the encoded frame and metadata, but it is not exhaustive here.

The technical solution in the embodiment of the present disclosure avoids independent motion estimation calculations by reusing the motion vector generated in the MCTF process; predicts the ROI of the current frame based on the physical ROI position of the reference frame to ensure real-time tracking; extracts facial feature points and establishes the spatial topological relationship in the first frame, and reuses the topological relationship to correct the predicted ROI position in subsequent frames, to maintain the cross-frame consistency. The differentiated quantization parameters are configured for different hierarchical regions; priority is given to ensuring the quality of key regions in combination with the dynamic bitrate allocation strategy; and the ROI-level metadata is output at the encoding end. By outputting the encoded frame and metadata, the decoding end can be supported to optimize the display, facilitating the decoder to implement regionalized post-processing according to the metadata (e.g., sharpening the main face) to restore the display quality of key regions. The technical solution in the embodiment of the present disclosure can improve the clarity of the main face while reducing the encoding delay, and significantly reduce the stuttering rate when the bandwidth fluctuates, achieving real-time live streaming push with high definition and low bitrate.

In some embodiments, establishing the initial ROI includes: using a lightweight face detection algorithm for a first frame of the video to locate a face region; and partitioning the face region according to facial key points into three regions: the main face region, the secondary face region and the background region, where the main face region includes a minimum rectangular region covering eyebrows, eyes, nose and mouth; the secondary face region includes a ring-shaped region covering cheeks and chin; and the background region includes a remaining region of the face.

Here, the lightweight face detection algorithm is an efficient algorithm with low consumption of computing resources designed for face detection tasks. Exemplarily, the lightweight face detection algorithm may be implemented by selecting a fast detection framework based on hierarchical structure or by using existing technologies such as region extraction combined with a specific pre-trained model. The selection may be made according to the actual situation, and is not limited in the present disclosure.

In the embodiment of the present disclosure, the first frame of image may be firstly extracted from the video stream as the first frame of the video. Subsequently, a lightweight model may be used to scan the image, detect the position of the face, and output the rectangular bounding box of the face as the positioning result. In particular, if multiple faces are detected in the first frame, a main face may be screened by rules such as region size and position, and the result may be verified or filtered to remove false detection. The above is only an exemplary description and is not intended to limit all possible cases of outputting the encoded frame and metadata, but it is not exhaustive here.

In the embodiment of the present disclosure, the facial key point detection algorithm may be firstly used to locate facial key points, including eyebrows, eyes, nose, mouth, cheeks and chin, and the coordinates of these key points are output as the basis for face region division. Subsequently, based on the key points of eyebrows, eyes, nose and mouth, the minimum rectangular boundary covering these feature points may be calculated as the main face region. Next, it is possible to expand outwards from the main face region to cover the cheeks and chin, to form a ring-shaped region as the secondary face region. In particular, the expansion range may be determined based on the proportion of the main face region. Then, the main face region and the secondary face region are subtracted from the ROI, and the remaining image region is extracted as the background region. Finally, the boundary coordinates of the main face region, the secondary face region and the background region may be saved, and the region division result may be stored as the metadata and simultaneously associated into the encoding information of the first frame. The above is only an exemplary description and is not intended to limit all possible configurations of three-region partitioning, but it is not exhaustive here.

In this way, the lightweight algorithm can quickly locate the face region in the first frame of the video, and meet the requirement of real-time video encoding. The main and secondary face regions of the face can be accurately partitioned by extracting facial key points, allowing encoding resources to be concentrated on key regions. By using facial key points to divide the face into the main face region, secondary face region and background region, the encoding quality of the important content is relatively high while the encoding quality of the non-important content is reduced, reducing the resource consumption of irrelevant regions and improving the user viewing experience. By outputting the region division result, the division result can be used as the metadata, which is suitable for dynamically adjusting the bitrate allocation and quantization parameters.

In some embodiments, the method for encoding the video further includes: for a plurality of face regions detected in the first frame, calculating a central region weight and an area weight of each face, where the central region weight reflects a proximity of a face center position to an image center, and the area weight reflects a proportion of a face region to a total image area; calculating a comprehensive score of each face according to a preset central weight factor and a preset area weight factor; selecting a face with a highest comprehensive score as a main tracking target, and determining a face region of the main tracking target as the main face region; and merging remaining face regions that are not selected as the main tracking target into the secondary face region.

Here, the central region weight is an evaluation metric used to measure how close the face region is to the image center. In the embodiment of the present disclosure, the central region weight reflects whether a face is located at the visual midpoint position in the image. In particular, the face closer to the image center is more in line with the user's focus of attention, and thus is given a higher weight.

Here, the area weight reflects the proportion of the face region to the total area of the entire image, and is used to evaluate the importance of the face region. In the embodiment of the present disclosure, the larger face is more prominent and requires more emphasis in encoding. In particular, the area weight is used to determine the importance of the face occupying a large visual proportion.

In the embodiment of the present disclosure, the lightweight face detection algorithm may be used to locate all face regions in the first frame and record the bounding box of each face. Then, the central region weight may be calculated. Specifically, the center point coordinates (x_{c}, y_{c}) of the image may be obtained first, then the center point coordinates (xᵢ, yᵢ) of each face region may be determined, and then the distance between the center point of each face and the center point of the image may be calculated. Finally, the calculated distance may be normalized and mapped to the interval [0,1], and then inverted to obtain the central region weight Cᵢ, so that the smaller the distance, the greater the weight. Further, the bounding box area of each face may be obtained, and then the ratio of the face area to the total image area may be calculated, and this ratio may be used as the area weight Aᵢ. The above is only an exemplary description and is not intended to limit all possible cases of calculating the central region weight and area weight, but it is not exhaustive here.

Exemplarily, the process of calculating the distance between the center point of each face and the center point of the image may be represented by the following formula:

$${L}_{i} = \sqrt{{( {x}_{i} - {x}_{c} )}^{2} + {( {y}_{i} - {y}_{c} )}^{2}}$$

In the formula, Lᵢ represents the distance between the center point of the i-th face and the center point of the image.

Exemplarily, the process of calculating the ratio of the face area to the total image area and using this ratio as the area weight Aᵢ may be represented by the following formula:

$${A}_{i} = \frac{{S}_{i}}{{S}_{total}}$$

In the formula, Sᵢ represents the area of the i-th face; and Sₜₒₜₐₗ represents the total image area.

Here, the central weight factor is a preset weight coefficient used to emphasize the importance of the central region weight in the comprehensive score. In the embodiment of the present disclosure, the central weight factor may be determined according to the actual scene requirements.

Here, the area weight factor is a preset weight coefficient used to adjust the influence of the area weight in the comprehensive score. In the embodiment of the present disclosure, the importance of the area weight may be highlighted or weakened by adjusting the area weight factor.

Here, the comprehensive score is the overall score of the face region calculated by weight factors in combination with the central region weight and the area weight. In the embodiment of the present disclosure, the comprehensive score may be used to compare the importance of multiple face regions.

In the embodiment of the present disclosure, the central weight factor and area weight factor may be set according to actual scene requirements or preset parameters, and then a comprehensive score is calculated for each face region. The above is only an exemplary description and is not intended to limit all possible cases of calculating the comprehensive score of each face, but it is not exhaustive here.

For example, the process of calculating the comprehensive score may be represented by the following formula:

$${P}_{i} = β \cdot {C}_{i} + γ \cdot {A}_{i}$$

In the formula, Pᵢ represents the comprehensive score of the i-th face region; β represents the central weight factor; and y represents the area weight factor.

Here, the main tracking target is the selected face region with the highest comprehensive score, and represents the most important face in the image. In the embodiment of the present disclosure, the main tracking target will be encoded with emphasis as the main face region.

In the embodiment of the present disclosure, all detected face regions may be traversed first, the comprehensive scores of all regions may be compared, and then the face region with the highest comprehensive score may be selected and marked as the main tracking target. Next, the facial key points may be further extracted from the face region of the main tracking target, then partitioned into the main face region. The above is only an exemplary description and is not intended to limit all possible cases of determining the main face region, but it is not exhaustive here.

In the embodiment of the present disclosure, the bounding boxes of the remaining face regions may be merged into a whole and marked as the secondary face region. The above is only an exemplary description and is not intended to limit all possible cases of determining the secondary face region, but it is not exhaustive here.

In this way, the importance of each face region in the image can be quantified by calculating the central region weight and area weight; and at the same time, the multi-target detection is supported, and the situation where there are multiple faces in the first frame can be processed, ensuring that no face region is missed. By adjusting the central weight factor and the area weight factor, the importance evaluation can be optimized for different scenes. By calculating the comprehensive score, the bias of a single indicator is avoided, making the result more consistent with actual scene requirements. The selection of the face with the highest comprehensive score as the main tracking target ensures accurate positioning of the key region, thereby concentrating encoding resources on the most important face region, and improving the encoding efficiency and video quality. After the secondary face regions are merged, it is ensured that other unselected face regions are still encoded, avoiding the neglect of secondary targets while processing them uniformly, and saving encoding resources.

In some embodiments, the method for encoding the video further includes: obtaining intra-frame prediction cost and inter-frame prediction cost of the current frame; in response to the intra-frame prediction cost not exceeding a product of a preset coefficient and the inter-frame prediction cost, determining that a scene switch occurs; and in response to the scene switch, interrupting a current ROI tracking process, using the current frame as a reference frame for a new scene, and re-executing an ROI establishment operation on the reference frame.

Here, the intra-frame prediction cost is the cost required for predictive encoding using the content of the current frame itself when measuring the compression efficiency of the current frame. In the embodiment of the present disclosure, the intra-frame prediction cost can reflect the resource consumption required for the current frame during intra-frame encoding.

Here, the inter-frame prediction cost is the cost required for predictive encoding using the reference frame when measuring the compression efficiency of the current frame. In the embodiment of the present disclosure, the inter-frame prediction cost can reflect the resource requirement of the current frame during inter-frame encoding.

In the embodiment of the present disclosure, the intra-frame predictive encoding may be performed on the current frame first, and the best intra-frame prediction mode may be selected; and the size of the prediction residual, the quantization coefficient and the encoding complexity may be measured to obtain the intra-frame prediction cost. Subsequently, the inter-frame predictive encoding may be performed using the reference frame; and the complexity of the motion vector, the matching accuracy of the reference frame and the processing cost of the encoding residual may be calculated to obtain the inter-frame prediction cost. The above is only an exemplary description and is not intended to limit all possible cases of obtaining the intra-frame prediction cost and inter-frame prediction cost, but it is not exhaustive here.

Here, the preset coefficient is a set weight factor used to adjust the comparison condition between the intra-frame prediction cost and inter-frame prediction cost. In the embodiment of the present disclosure, the preset coefficient can reflect the relative importance of intra-frame encoding and inter-frame encoding.

Here, the scene switch refers to a significant change in the video content. Exemplarily, the scene switch may be a transition from one scene to another scene, causing the content of the reference frame to be no longer related to the content of the current frame. In the embodiment of the present disclosure, the scene switch process is accompanied by a sharp increase in the inter-frame prediction cost, while the intra-frame prediction cost is relatively low.

In the embodiment of the present disclosure, the relationship between intra-frame prediction cost and inter-frame prediction cost may be compared first. When the intra-frame prediction cost does not exceed the product of the preset coefficient and the inter-frame prediction cost, it is considered that a scene switch has occurred. Specifically, since the scene switch is accompanied by a sharp drop in the prediction efficiency of the reference frame for the current frame, the inter-frame prediction cost is significantly higher than the intra-frame prediction cost at this time, indicating that the content of the reference frame can no longer effectively predict the current frame. Exemplarily, the preset coefficient may be in the range of [0.3, 0.6]. In particular, the preset coefficient may also be selected from other value ranges according to the actual situation, and is not limited in the present disclosure. The above is only an exemplary description and is not intended to limit all possible cases of determining that a scene switch occurs, but it is not exhaustive here.

In the embodiment of the present disclosure, when a scene switch occurs, the reference frame and the current frame are no longer correlated, so the ROI tracking process based on the reference frame, such as motion vector prediction and feature point correction, can be stopped. Further, the current frame may be marked as a scene switch point, the relevant processes may be re-initialized during encoding, and the current frame may be set as a new reference frame for inter-frame prediction of subsequent frames. In particular, the motion vector, ROI information and other data related to the previous reference frame may be cleared. Next, the lightweight face detection algorithm may be used on the new reference frame to relocate the face region and establish a new ROI hierarchical division, thereby partitioning the main face region, secondary face region and background region based on feature point detection. Finally, the new ROI may be correlated into the encoding process to provide an accurate prediction basis for subsequent frames. The above is only an exemplary description and is not intended to limit all possible cases of re-executing the ROI establishment operation, but it is not exhaustive here.

Exemplarily, in the process of re-executing the ROI establishment operation, the current frame where the scene switch occurs may be used as the first frame of the new scene, the initial ROI detection process of face detection and hierarchical division is re-executed on this frame, this frame is used as the reference frame for the next frame in time, and then the spatial topology relationship of feature points established for the ROI of the current frame is used as the spatial topology relationship of feature points of the subsequent frame.

In this way, the calculations of the intra-frame prediction cost and inter-frame prediction cost can dynamically evaluate the encoding efficiency of the current frame, and provide an accurate basis for determining the scene switch. By comparing the intra-frame prediction cost with the inter-frame prediction cost, significant changes in video scenes can be effectively detected to ensure that the encoding process adapts to new scenes. When a scene switch occurs, the content of the reference frame and the content of the current frame differs significantly, and the inter-frame prediction will lead to a decrease in encoding efficiency. The inefficient reference frame can be avoided by determining the scene switch. After interrupting the current ROI tracking process, the use of the incorrect reference frame to predict the ROI position is avoided, improving the ROI positioning accuracy in subsequent frames. The initialization of the new reference frame can adapt to the scene change in a timely manner, avoiding a decrease in encoding performance due to the reference frame error. The re-establishment of the ROI can ensure that key regions in the new scene are encoded with high quality, thus improving the video quality.

In some embodiments, the step of reusing a motion vector generated by the reference frame in a motion compensated temporal filter process to determine an ROI position prediction value of the current frame, includes: dividing a physical ROI of the reference frame into a macroblock set according to a standard macroblock size; obtaining motion vectors calculated for all macroblocks in the motion compensated temporal filter process; and using a motion vector aggregation algorithm to generate the ROI position prediction value of the current frame.

Here, the physical ROI of the reference frame refers to an actual position region determined for the ROI extracted from the reference frame after precise detection and correction in the video encoding process. In the embodiment of the present disclosure, this region is a part to be encoded with emphasis in the reference frame.

Here, the standard macroblock is a fixed-size rectangular block obtained by dividing the image in the video encoding process, and is used for subsequent compression. In the embodiment of the present disclosure, a macroblock is the basic unit of video encoding. Exemplarily, the typical macroblock size is 16×16 pixels in the H.264 standard; and similarly, the typical macroblock size ranges from 8×8 pixels to 64×64 pixels in the H.265 standard.

Here, the macroblock set refers to a set formed by dividing the physical ROI of the reference frame into several macroblocks. In the embodiment of the present disclosure, the macroblocks in the macroblock set collectively cover the entire ROI.

In the embodiment of the present disclosure, the detected ROI may be extracted from the reference frame first, and the ROI may be divided into several rectangular blocks according to the preset standard macroblock size, and the divided rectangular blocks may be used as macroblocks. In particular, if the boundaries of the ROI do not perfectly match the macroblock size, the division may be accomplished by filling or cutting. Finally, all the divided macroblocks may be recorded as a set, where each macroblock contains its position coordinates and pixel or feature data. The above is only an exemplary description and is not intended to limit all possible cases of dividing the macroblock set, but it is not exhaustive here.

In the embodiment of the present disclosure, the MV is used to estimate the motion relationship between the reference frame and the current frame, and typical methods include block matching method and optical flow method. During the MCTF process, motion estimation is performed on each macroblock to find the most matching block in the current frame, and then an MV is generated. Specifically, the motion vector of each macroblock contains a horizontal component and a vertical component; the horizontal component reflects the displacement of the macroblock in the horizontal direction; and similarly, the vertical component reflects the displacement of the macroblock in the vertical direction. Finally, the motion vector of each macroblock may be bound to the spatial position thereof, to thereby obtain the MV of each macroblock. The above is only an exemplary description and is not intended to limit all possible cases of obtaining the MV, but it is not exhaustive here.

Here, the aggregation algorithm refers to generating a whole result by merging, integrating or optimizing the MVs of multiple macroblocks. In the embodiment of the present disclosure, the aggregation algorithm is used to synthesize the motion information of the macroblock set into the ROI position prediction value of the current frame.

Here, the ROI position prediction value is a position estimation result of the ROI in the current frame obtained through motion vector analysis. In the embodiment of the present disclosure, the ROI position prediction value is a predicted position after the ROI position of the reference frame is adjusted by motion compensation.

In the embodiment of the present disclosure, the horizontal and vertical components may be respectively extracted from the motion vectors of all macroblocks, and the median of the horizontal components and the median of the vertical components may be respectively calculated, to eliminate the influence of abnormal motion vectors. Next, the center point coordinates of the ROI in the current frame may be obtained, and then the median of the horizontal components and the median of the vertical components may be superimposed onto the center point coordinates of the ROI in the current frame, to obtain the predicted center point of the ROI in the current frame. Finally, the predicted center point may be used as the center point of the ROI in the current frame, and the width and height of the region may be kept consistent with those of the ROI in the reference frame, to reconstruct the ROI position in the current frame. Specifically, the ROI position prediction value includes the center point coordinates and region boundaries of the ROI in the current frame, and the region boundaries may be calculated from the center point and size. The above is only an exemplary description and is not intended to limit all possible cases of generating the ROI position prediction value, but it is not exhaustive here.

In this way, each prediction is based on the latest corrected physical ROI, ensuring that the predicted position does not deviate from reality due to error transmission. The aggregation using the median of motion vectors filters out abnormal or noisy motion vectors effectively, and improves the prediction accuracy. The computational complexity of motion compensation is reduced by dividing the ROI into the macroblock set. After the motion vectors are aggregated, the prediction result is generated directly without the need to re-detect the ROI, improving the real-time processing efficiency significantly. For cases where the ROI in a video moves over time, the motion compensation and the aggregation algorithm can dynamically adjust the ROI position to ensure the effectiveness of the prediction result.

In some embodiments, the method for encoding the video further includes: calculating consistency of motion vectors of all macroblocks within the physical ROI of the reference frame as a confidence score; in response to the confidence score exceeding a preset occlusion determination threshold, determining that local occlusion occurs in a corresponding macroblock region; and for the macroblock region with local occlusion, using a feature point matching method to update position information of the macroblock region in the current frame.

Here, the confidence score is an indicator to measure the consistency of motion vectors of macroblocks within the physical ROI of the reference frame. In the embodiment of the present disclosure, the confidence score can reflect whether the motion vectors of macroblocks within the region tend to move in a consistent manner. In particular, the confidence score is used to judge whether there is occlusion or irregular motion within the ROI. Once occlusion occurs, the occlusion will cause the motion vectors of macroblocks to be inconsistent, thereby reducing the confidence score.

In the embodiment of the present disclosure, the statistical feature of motion vectors of all macroblock within the physical ROI of the reference frame may be calculated first, and the statistical feature may be used as a consistency index. Exemplarily, the statistical feature may be either the mean or the variance. When the mean is used as the statistical feature, the average direction and magnitude of motion vectors of all macroblocks may be calculated; and similarly, when the variance is used as the statistical feature, the degree of dispersion of motion vectors may be evaluated. Next, the confidence score may be calculated based on the consistency index. In particular, the lower the confidence score, the more dispersed the motion vectors, and the stronger the inconsistency. The above is only an exemplary description and is not intended to limit all possible cases of calculating the confidence score, but it is not exhaustive here.

Exemplarily, when the variance is chosen as the consistency index, the process of calculating the confidence score may be represented by the following formula:

$$C o = \frac{1}{1 + D}$$

In the formula, Co represents the confidence score; and D represents the variance of MVs of all macroblocks.

Specifically, if the MVs are highly consistent, the variance is relatively small and the confidence score is close to 1; if the MVs are significantly different, the variance increases and the confidence score decreases, approaching 0.

Here, the occlusion determination threshold is a preset value used to compare with the confidence score to judge whether certain macroblocks within the ROI may be occluded. In the embodiment of the present disclosure, the occlusion determination threshold may be used as a sensitivity adjustment parameter for occlusion detection. In particular, the lower the value of the occlusion determination threshold, the more sensitive the determination of occlusion; conversely, the higher the value, the greater the tolerance for occlusion. Exemplarily, the occlusion determination threshold may be in the range of [0.2, 0.5]. In particular, the occlusion determination threshold may also be selected from other value ranges according to the actual situation, and is not limited in the present disclosure.

In the embodiment of the present disclosure, a confidence score may be calculated for each ROI macroblock region and compared with the occlusion determination threshold. If the confidence score is lower than the preset occlusion determination threshold (e.g., 0.3), it is determined that local occlusion has occurred in the macroblock region. Specifically, the occlusion may cause a significant difference or irregular distribution in motion vectors of the reference frame and the current frame in the local region, manifested as an increase in the inconsistency of motion vectors, thus reducing the confidence score. The above is only an exemplary description and is not intended to limit all possible cases of determining local occlusion, but it is not exhaustive here.

Here, the feature point matching method is an algorithm used to detect and track feature points in the ROI. In the embodiment of the present disclosure, the position information of the local region may be updated by matching feature points in the current frame and the reference frame.

In the embodiment of the present disclosure, the feature point detection algorithm may be used to extract key points within the occluded macroblock region of the reference frame. Subsequently, feature point detection may be run again in the corresponding position region of the current frame to obtain a candidate set of feature points. Next, the feature points of the reference frame and the current frame may be compared to find matching pairs, and then the displacement of the local region may be estimated based on the matching feature point pairs. For example, the matching method may use Euclidean distance or Hamming distance. Finally, the feature point matching result may be mapped to the macroblock region to update the position of the occluded macroblock in the current frame. The above is only an exemplary description and is not intended to limit all possible cases of updating the position information, but it is not exhaustive here.

Exemplarily, when a feature point is occluded, the actual straight-line distance between each pair of visible feature points in the current frame may be measured first; when the relative deviation between the measured distance value of a pair of feature points and the corresponding distance value stored in the relative distance matrix exceeds a preset error threshold (for example, the preset error threshold ranges from 20% to 40%), the feature point is determined to be unpositioned; all feature points determined to be unpositioned are removed; and only the remaining valid feature points are used to recalculate the correction amount of the ROI position.

Thus, by calculating the consistency of motion vectors, abnormal motions within macroblock regions can be effectively detected, and local occlusion can be accurately identified. By setting different ranges for the occlusion determination threshold, the occlusion detection requirements of different scenarios can be adapted. When the occlusion causes the motion vector to be invalid, the feature point matching method can use local features for matching, to ensure the update of the position information of the occluded region and ensure the integrity of the ROI region. The error propagation is reduced by detecting and correcting the motion vector of the occluded region in real time.

In some embodiments, the step of correcting the ROI position prediction value based on a spatial topological relationship of feature points in the initial ROI, includes: calculating expected position coordinates of all feature points in the current frame according to the spatial topological relationship of feature points recorded in the initial ROI in combination with the ROI position prediction value; obtaining actual position coordinates of corresponding feature points in the current frame by a facial feature point detection algorithm; calculating a spatial transformation parameter based on a correspondence between expected position coordinates and actual position coordinates; and applying the spatial transformation parameter to correct the ROI position prediction value.

Here, the expected position coordinates are the theoretical positions of the feature points in the current frame calculated from the spatial topological relationship of the feature points recorded in the initial ROI and the ROI position prediction value.

In the embodiment of the present disclosure, the spatial topological relationship of the feature points of the initial ROI may be obtained first, and the initial topological relationship may be mapped to the current frame by using the predicted center point, size and shape of the ROI. Exemplarily, the relative offset of the feature points may be added on the basis of the center point of the ROI position prediction value, to thereby obtain the expected position coordinates. Subsequently, the theoretical position of each feature point in the facial feature points in the current frame may be calculated based on the predicted ROI position, to form a set of expected positions of the feature points. The above is only an exemplary description and is not intended to limit all possible cases of calculating the expected position coordinates of feature points, but it is not exhaustive here.

Here, the facial feature point detection algorithm is used to detect key feature points in a face and extract the actual position coordinates of the feature points.

Here, the actual position coordinates are the real positions of the feature points detected in the current frame by the facial feature point detection algorithm.

In the embodiment of the present disclosure, the facial feature point detection algorithm may be run first in the current frame to accurately extract the actual positions of feature points such as eyes, nose and mouth. Exemplarily, the key points may be located using a deep learning model, or the edges or corners may be extracted by the image processing technology. Then, the detected coordinates of the feature points may be recorded to form the actual position coordinates of the corresponding feature points. The above is only an exemplary description and is not intended to limit all possible cases of obtaining the actual position coordinates of feature points, but it is not exhaustive here.

Here, the spatial transformation parameter is used to describe the transformation information of the geometric relationship between expected positions and actual positions. In the embodiment of the present disclosure, the spatial transformation parameter may be represented by a mathematical model, and may include a translation parameter, a rotation parameter, a scaling parameter, etc.

In the embodiment of the present disclosure, after corresponding the expected position coordinates to the actual position coordinates one by one, the deviation between coordinates in each corresponding group may be compared, and then the geometric transformation parameter may be calculated based on the deviation information. Exemplarily, the offset between the expected position center and the actual position center may be calculated to obtain the translation parameter; the angular change of the feature point set may be analyzed to obtain the rotation parameter; and the change ratio of the distance between feature points may be calculated to obtain the scaling parameter. In particular, a linear or affine transformation model may also be used to fit the transformation relationship from expected positions to actual positions. The above is only an exemplary description and is not intended to limit all possible cases of calculating the spatial transformation parameter, but it is not exhaustive here.

In the embodiment of the present disclosure, the spatial transformation parameter may be applied to the predicted ROI position, and then the corrected ROI position may be used as the final ROI position of the current frame. The above is only an exemplary description and is not intended to limit all possible cases of correcting the ROI position prediction value, but it is not exhaustive here.

Exemplarily, in the process of correcting the ROI position prediction value, the expected position coordinates of all feature points in the current frame may be firstly calculated based on the ROI position of the current frame predicted from the motion vector as well as the normalized coordinates. Subsequently, the actual position coordinates of all feature points in the current frame may be detected. Next, the correction amount of the ROI position may be solved by minimizing the total distance deviation between the actual and expected position coordinates of all feature points. Finally, the correction amount may be applied to adjust the predicted position of the ROI region.

In this way, the ROI position prediction value is corrected by the spatial transformation parameter, reducing deviations caused by scene changes or prediction errors. The facial feature point detection algorithm can adapt to various expression changes, head movements or occlusions, ensuring the detection accuracy of actual positions. Meanwhile, the ROI position can be dynamically adjusted using the spatial transformation parameter to adapt to dynamically changed scenes, and the corrected ROI position is closer to the real region, avoiding the resource waste caused by misjudgment.

In some embodiments, the step of dynamically allocating the three-region bitrate according to a real-time network bandwidth, includes: in response to detecting that the real-time network bandwidth is not lower than a preset bandwidth threshold, controlling a proportion of a bitrate allocated for the main face region to a total bitrate to be not lower than a preset proportion threshold; and in response to detecting that the real-time network bandwidth is lower than the preset bandwidth threshold, ensuring that the bitrate of the main face region is not lower than a preset minimum guaranteed bitrate, and compressing the bitrate of the background region to be within a first compression coefficient range of an original baseline value.

Here, the bandwidth threshold is a preset reference value. In the embodiment of the present disclosure, the bandwidth threshold can be used to judge whether the network bandwidth is sufficient. In particular, if the network bandwidth is greater than or equal to the bandwidth threshold, the network condition is considered good and a higher bitrate may be allocated; otherwise, the bitrate needs to be reduced to accommodate the bandwidth limitation.

Here, the proportion threshold is the minimum proportion of the bitrate allocated to the main face region to the total bitrate when the bandwidth is sufficient. In the embodiment of the present disclosure, the proportion threshold can ensure that the main face region obtains sufficient bitrate resources to maintain high-quality encoding when the network bandwidth is sufficient. Exemplarily, the proportion threshold may be in the range of [0.5, 0.7]. In particular, the proportion threshold may also be selected from other value ranges according to the actual situation, and is not limited in the present disclosure.

In the embodiment of the present disclosure, the current network bandwidth value may be obtained in real time through a network status monitoring mechanism, and then the current network bandwidth value may be compared with the bandwidth threshold. Exemplarily, the process of obtaining the current network bandwidth value may be performed by the Real-time Transmission Control Protocol (RTCP) or the like. Next, when the real-time network bandwidth is detected to be no less than the preset bandwidth threshold, that is, when the bandwidth is considered sufficient, the bitrate of the main face region may be allocated according to the proportional threshold, that is, the product of the total bitrate value corresponding to the real-time network bandwidth and the proportional threshold is used as the bitrate of the main face region. The above is only an exemplary description and is not intended to limit all possible cases of controlling bitrate allocation, but it is not exhaustive here.

Here, the minimum guaranteed bitrate is the minimum encoding bitrate that must still be allocated to the main face region when the bandwidth is insufficient, in order to ensure the basic visual quality of this region. In the embodiment of the present disclosure, the minimum guaranteed bitrate can prevent a severe degradation in the quality of the main face region, and ensure the clarity of the key region even if the network bandwidth is poor.

Here, the original baseline value is the initial bitrate allocated to the background region when the bandwidth is sufficient. In the embodiment of the present disclosure, the original baseline value is the normal encoding state of the background region. In particular, when the network bandwidth is insufficient, bitrate compression may be performed on the background region based on the original baseline value.

Here, the first compression coefficient is the compression ratio range for the background region when the bandwidth is insufficient, and is used to reduce the bitrate allocation of the background region to save bandwidth. In the embodiment of the present disclosure, the first compression coefficient can control the bitrate compression amplitude of the background region to maintain the effective utilization of the network bandwidth. Exemplarily, the first compression coefficient may be in the range of [0.5, 0.8]. In particular, the first compression coefficient may also be selected from other value ranges according to the actual situation, and is not limited in the present disclosure.

In the embodiment of the present disclosure, when the network bandwidth is insufficient, the bitrate of the main face region is first ensured to be no lower than the minimum guaranteed bitrate, that is, the minimum guaranteed bitrate is compared with the product of the total bitrate value and the proportion threshold, and the larger one is taken as the bitrate of the main face region. Subsequently, the bitrate of the background region may be compressed and controlled within the range of the first compression coefficient of the original reference value, that is, the product of the original reference value and the first compression coefficient is used as the bitrate of the background region. The above is only an exemplary description and is not intended to limit all possible cases of compressing the bitrate of the background region, but it is not exhaustive here.

In this way, prioritizing the allocation of bitrate to the main face region can ensure the encoding quality of the main face region and improve the user experience, regardless of whether the network bandwidth is sufficient or insufficient. Through the minimum guarantee mechanism, the main face region still maintains the lowest bitrate even if the network bandwidth is insufficient, avoiding severe distortion in the key video region. By detecting the network bandwidth in real time, the system can dynamically adjust the bitrate allocation strategy to ensure the stability of the video stream under different bandwidth conditions. By controlling the range of the first compression coefficient, the bitrate compression is flexibly performed on the background region, improving the bandwidth utilization efficiency.

In some embodiments, the method for encoding the video further includes: when the bandwidth is insufficient for first trigger, compressing the bitrate of the background region to a specific value within the first compression coefficient range; if the bandwidth continues to decrease and a decrease per unit time exceeds a preset rate threshold, compressing the bitrate of the secondary face region to be within a second compression coefficient range; and ensuring that the bitrate of the main face region is not lower than a protection redundancy coefficient multiple of the preset minimum guaranteed bitrate during compression.

In the embodiment of the present disclosure, the network bandwidth may be monitored in real time, and the bitrate compression logic of the background region is triggered when the bandwidth is detected to be lower than the preset bandwidth threshold for the first time. Specifically, a specific compression value may be selected from the first compression coefficient range, and the bitrate of the background region may be adjusted to the product of the compression value and the total bitrate, to release bandwidth resources to the main face region and secondary face region. The above is only an exemplary description and is not intended to limit all possible cases of compressing the bitrate of the background region, but it is not exhaustive here.

Here, the rate threshold is a preset standard for the decrease rate of bandwidth. In the embodiment of the present disclosure, the rate threshold can be used to judge whether the network bandwidth decreases rapidly within a unit of time.

Here, the second compression coefficient is the compression range of the bitrate of the secondary face region when the bandwidth decreases sharply, and is used to reduce the bitrate allocation of the secondary face region. In the embodiment of the present disclosure, the second compression coefficient can dynamically adjust the bitrate allocation of the secondary face region, to reserve more bandwidth resources for the main face region. Exemplarily, the second compression coefficient may be in the range of [0.8, 0.95]. In particular, the second compression coefficient may also be selected from other value ranges according to the actual situation, and is not limited in the present disclosure.

In the embodiment of the present disclosure, the decrease rate of bandwidth may be calculated in real time. If the decrease exceeds the rate threshold, the bitrate compression logic of the secondary face region is triggered. Specifically, a specific compression value may be selected from the second compression coefficient range, and the bitrate of the secondary face region may be adjusted to the product of the compression value and the total bitrate, to release bandwidth resources for the main face region. The above is only an exemplary description and is not intended to limit all possible cases of compressing the bitrate of the secondary face region, but it is not exhaustive here.

Here, the protection redundancy coefficient is a guarantee multiple for the bitrate of the main face region when the bandwidth decreases sharply, and is used to ensure the minimum visual quality of the region. In the embodiment of the present disclosure, even if the bandwidth decreases rapidly, the protection redundancy coefficient can ensure that no severe distortion occurs in the main face region. Exemplarily, the protection redundancy coefficient may be in the range of [1.1, 1.3]. In particular, the protection redundancy coefficient may also be selected from other value ranges according to the actual situation, and is not limited in the present disclosure.

In the embodiment of the present disclosure, the minimum value of the main region bitrate may be calculated based on the minimum guaranteed bitrate and the protection redundancy coefficient. Exemplarily, the product of the minimum guaranteed bitrate and the protection redundancy coefficient may be used as the minimum value of the bitrate of the main region. Subsequently, the bitrate allocated to the main face region is ensured to be no less than the minimum value of the main region bitrate even if the bandwidth decreases rapidly, thereby guaranteeing the visual quality of the key region. The above is only an exemplary description and is not intended to limit all possible cases of bitrate protection of the main face region, but it is not exhaustive here.

In this way, the main face region always maintains a high bitrate, and can meet the lowest visual quality requirement even if the bandwidth decreases rapidly, avoiding distortion or blurring. During the compression process, the quality of the main face region is prioritized, and the allocation priority of encoding resources is clearly defined. The bitrate of the background region is compressed when insufficient bandwidth is detected for the first time, to avoid affecting the main and secondary regions. The bandwidth change is dynamically monitored based on the rate threshold, and the compression of the bitrate of the secondary region is triggered in time, to ensure the stability of the video stream. When the bandwidth further decreases, the bitrate of the secondary face region is compressed to further save bandwidth resources. The main face region remains clear at all times, and the quality of the key regions of the video stream will not be affected even if the network bandwidth decreases.

In some embodiments, the step of configuring differentiated quantization parameters for a main face region, a secondary face region and a background region after correction respectively, includes: setting a lowest quantization parameter offset value for the main face region so that a quantization parameter of the main face region is lower than a base quantization parameter of an encoder, enabling a first prediction mode combination, and allocating an encoding resource with highest priority; setting a moderate quantization parameter offset value for the secondary face region so that a quantization parameter of the secondary face region is equal to or slightly higher than the base quantization parameter of the encoder, enabling a second prediction mode combination, and allocating an encoding resource with regular priority; and setting a highest quantization parameter offset value for the background region, enabling a third prediction mode combination, and allocating an encoding resource with lowest priority.

Here, the first prediction mode combination is a set of prediction modes allocated by the encoder to the main face region. In the embodiment of the present disclosure, the first prediction mode combination may include prediction modes divided by block sizes of 4×4 and 8×8.

In the embodiment of the present disclosure, the main face region is the key region that the user pays attention to, so the lowest quantization parameter is required to reduce the quantization error. Exemplarily, the quantization parameter of the main face region may be the difference between the base quantization parameter and the lowest quantization parameter offset value. Subsequently, the first prediction mode combination may be enabled, the block sizes of 4×4 and 8×8 are used for division, and the main face region is encoded with high fine-granularity. In particular, the size division of 4×4 is suitable for processing regions with complex textures and details, such as eyes and mouths, while the size division of 8×8 is suitable for processing slightly larger uniform regions. Further, the main face region obtains more computing resources and bandwidth to ensure that the details in this region are preserved with the highest quality. The above is only an exemplary description and is not intended to limit all possible cases of enabling the first prediction mode combination, but it is not exhaustive here.

Here, the second prediction mode combination is a set of prediction modes allocated by the encoder to the secondary face region. In the embodiment of the present disclosure, the second prediction mode combination may include prediction modes divided by block sizes of 8×8 and 16×16.

In the embodiment of the present disclosure, the secondary face region is not the main focus of the user but still requires the good visual quality, the moderate quantization parameter is needed to reduce the quantization error. Exemplarily, the quantization parameter of the secondary face region may be the difference between the base quantization parameter and the moderate quantization parameter offset value. Subsequently, the second prediction mode combination may be enabled, the block sizes of 8×8 and 16×16 are used for division, and the secondary face region is encoded with medium fine-granularity. Further, the computing resources and bandwidth allocated to the secondary face region are lower than those allocated to the main face region but higher than those allocated to the background region, ensuring a balance between visual quality and resource allocation. The above is only an exemplary description and is not intended to limit all possible cases of enabling the second prediction mode combination, but it is not exhaustive here.

Here, the third prediction mode combination is a set of prediction modes allocated by the encoder to the background region. In the embodiment of the present disclosure, the third prediction mode combination may include prediction modes divided by a block size of 16×16 or larger.

In the embodiment of the present disclosure, the background region is the part that the user pays the least attention to, so the highest quantization parameters can be accepted to reduce the retention of background details and save resources. Exemplarily, the quantization parameter of the background region may be the difference between the base quantization parameter and the highest quantization parameter offset value. Subsequently, the third prediction mode combination may be enabled, the block size of 16×16 or larger is used for division, and the background region is encoded with low fine-granularity. Further, the background region obtains the least computing resources and bandwidth, to prioritize the encoding quality of the main face region. The above is only an exemplary description and is not intended to limit all possible cases of enabling the third prediction mode combination, but it is not exhaustive here.

In this way, the main face region uses the lowest quantization parameter and small block division to ensure that the key region that the user focuses on in the video achieves the highest encoding quality, and at the same time, the first prediction mode combination allows for fine encoding of complex details, reducing the visual distortion and enhancing the user experience. The resources are concentrated on the main face region, the secondary face region is balanced, and the resource occupation of the background region is reduced, achieving the efficient utilization of encoding resources. The quantization parameters are dynamically adjusted based on the importance of the video content to ensure that details in the key region are clear while resources for the secondary and background regions are reduced. At the same time, different block division methods are used for different regions to adapt to the texture complexity of the regions, achieving the best balance between quality and efficiency.

In some implementations, the step of detecting the ROI in the first frame may be performed first. Specifically, the lightweight face detection algorithm may be used to detect the face region in the first frame of the live video, determine the initial ROI and record its position, size, shape and other information. At the same time, based on the key feature points (such as eyes, nose, mouth, etc.) of the face, the face region is further partitioned into three hierarchical levels: a main face region (including the core of the facial features), a secondary face region (the facial contour and surrounding region), and a background region (the rest of the face).

Further, the ROI tracking step based on MCTF motion estimation may be performed. Specifically, the MV obtained in the MCTF process may be reused to continuously track the facial ROI region. Exemplarily, the MV of each macroblock between the current frame and the adjacent reference frame may be calculated in the motion estimation stage of the MCTF; in particular, this process is usually a necessary module of the encoder and therefore does not consume additional time; then the face ROI determined in the first frame may be divided into multiple macroblocks, and the position of the ROI in the current frame may be predicted by performing aggregation analysis according to the motion vectors of adjacent macroblocks; and finally, the predicted position may be corrected in combination with the relative positional relationship of the key feature points of the face to obtain the accurate ROI position, and the region ranges of the three hierarchical levels may be updated simultaneously.

Furthermore, the scene switch judgment step may be performed. Specifically, it may be judged whether a scene switch occurs by calculating the difference in image features between the current frame and adjacent frame. Exemplarily, it may be judged whether a scene switch occurs by calculating the cost difference between the intra-frame prediction mode and the inter-frame prediction mode of the current frame. That is, if the cost of the intra-frame prediction mode is much lower than the cost of the inter-frame mode, it is judged that a scene switch occurs; otherwise, it is judged that no scene switch occurs.

Specifically, if a scene switch occurs, the ROI detection step is re-executed to update the face ROI and the division of three hierarchical levels; if no scene switch occurs, the ROI and the division of hierarchical levels obtained based on MCTF motion estimation tracking are continued to be used.

Furthermore, the bitrate-hierarchical encoding step may be performed. Specifically, the encoding parameters of the encoder may be firstly adjusted for differentiated encoding, according to the determined ROI and three hierarchical levels thereof. For the main face region, a lower quantization parameter, a higher encoding quality level and a more refined prediction mode are used to ensure clear details of facial features; for the secondary face region, the quantization parameter is set to a medium level, and a conventional prediction mode is used; for the background region, the quantization parameter is appropriately increased, a coarser prediction mode is used, the encoding quality is reduced, and the bitrate allocation is decreased. At the same time, the bitrate proportion of each hierarchical level is adjusted in real time according to the network bandwidth. When the bandwidth is sufficient, the bitrate proportion of the main face region is increased; when the bandwidth is insufficient, priority is given to ensure the basic bitrate requirement of the main face region.

Finally, the encoding output step may be performed. Specifically, video frames that have undergone bitrate-hierarchical encoding may be encapsulated to generate a live video stream for outputting.

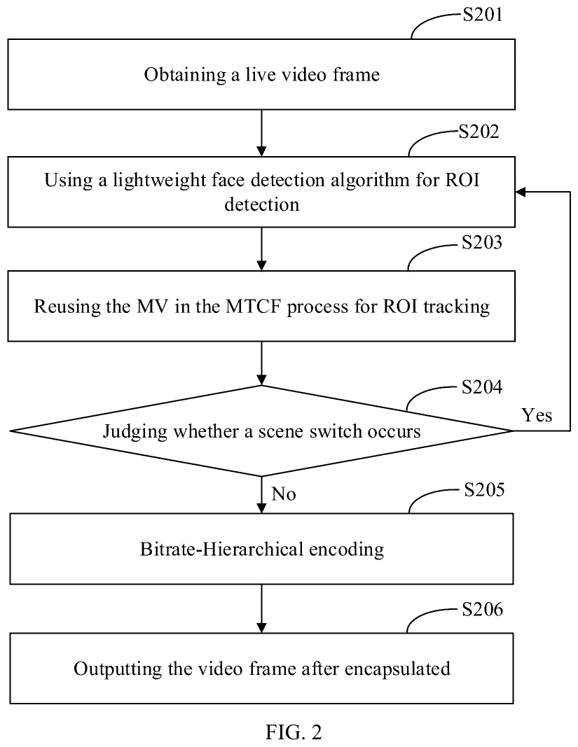

FIG. 2 is another schematic flow chart of a method for encoding a video according to an embodiment of the present disclosure. As shown in FIG. 2, the method for encoding the video includes:
S201: obtaining a live video frame.
S202: using a lightweight face detection algorithm for ROI detection.
S203: reusing the MV in the MTCF process for ROI tracking.
S204: judging whether a scene switch occurs. If a scene switch occurs, proceed to S202; if no scene switch occurs, proceed to S205.
S205: bitrate-hierarchical encoding.
S206: outputting the video frame after encapsulated.

This solution gives a three-in-one low-latency high-definition encoding framework of “tracking-grading-flow control”, in which redundant calculations are eliminated by reusing the motion vector of motion compensated temporal filter, significantly reducing the processing latency of the motion tracking module; and independent motion estimation operations are avoided, achieving ROI cross-frame tracking with near-zero overhead and thus improving the real-time performance of encoding. The spatial consistency of feature points is maintained by a cross-frame reuse mechanism of the first frame topological relationship; the quality fluctuations of feature points reconstructed frame by frame are eliminated, ensuring clarity of details in key regions and thus optimizing the encoding quality; the quality and smoothness are intelligently balanced when the bandwidth fluctuates in combination with hierarchical encoding and dynamic bitrate allocation, enhancing the bandwidth adaptability; and the risk of live streaming stuttering is reduced by coordinating the optimization of motion tracking and bitrate control. Under the premise of ensuring the visual quality of the main face region, the optimization of overall bitrate efficiency is achieved.

It should be understood that the schematic diagram shown in FIG. 2 is only illustrative and not restrictive and is scalable, those skilled in the art can make various obvious changes and/or replacements based on the example of FIG. 2, and the obtained technical solutions still belong to the disclosure scope of the embodiments of the present disclosure.

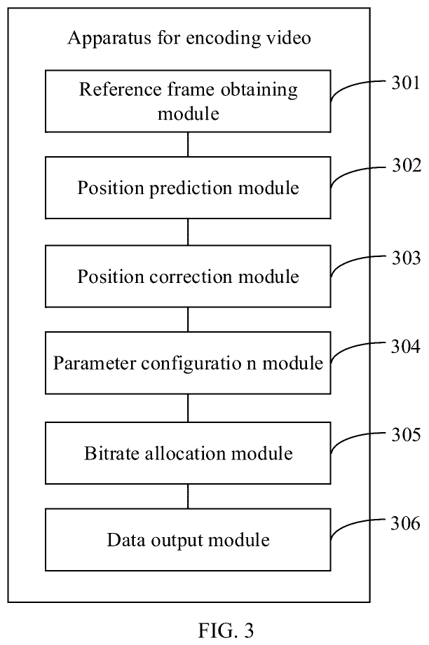

An embodiment of the present disclosure provides an apparatus for encoding a video. As shown in FIG. 3, the apparatus may include: a reference frame obtaining module 301 configured to obtain a reference frame that is adjacent to a current frame and has established hierarchical division of an initial ROI; a position prediction module 302 configured to reuse a motion vector generated by the reference frame in a motion compensated temporal filter process to determine an ROI position prediction value of the current frame; a position correction module 303 configured to extract facial feature points from the current frame, and correct the ROI position prediction value based on a spatial topological relationship of feature points in the initial ROI; a parameter configuration module 304 configured to configure differentiated quantization parameters for a main face region, a secondary face region and a background region after correction respectively; a bitrate allocation module 305 configured to dynamically allocate a three-region bitrate according to a real-time network bandwidth; and a data output module 306 configured to output an encoded frame of the current frame and associated ROI-level metadata; where the ROI-level metadata includes: boundary coordinates of the main face region, the secondary face region and the background region; offset values of quantization parameters corresponding to all regions; and bitrate allocation weight values of all regions.

In some embodiments, the apparatus for encoding the video further includes: a face localization module 307 (not shown in FIG. 3) configured to use a lightweight face detection algorithm for a first frame of the video to locate a face region; and a hierarchy division module 308 (not shown in FIG. 3) configured to partition the face region according to facial key points into three regions: the main face region, the secondary face region and the background region, where the main face region includes a minimum rectangular region covering eyebrows, eyes, nose and mouth; the secondary face region includes a ring-shaped region covering cheeks and chin; and the background region includes a remaining region of the face.

In some embodiments, the apparatus for encoding the video further includes: a weight calculation module 309 (not shown in FIG. 3) configured to, for a plurality of face regions detected in the first frame, calculate a central region weight and an area weight of each face, where the central region weight reflects a proximity of a face center position to an image center, and the area weight reflects a proportion of a face region to a total image area; a comprehensive score calculation module 310 (not shown in FIG. 3) configured to calculate a comprehensive score of each face according to a preset central weight factor and a preset area weight factor; a main face determining module 311 (not shown in FIG. 3) configured to select a face with a highest comprehensive score as a main tracking target, and determine a face region of the main tracking target as the main face region; and a secondary face determining module 312 (not shown in FIG. 3) configured to merge remaining face regions that are not selected as the main tracking target into the secondary face region.

In some embodiments, the apparatus for encoding the video further includes: a prediction cost obtaining module 313 (not shown in FIG. 3) configured to obtain intra-frame prediction cost and inter-frame prediction cost of the current frame; a scene switching determining module 314 (not shown in FIG. 3) configured to, in response to the intra-frame prediction cost not exceeding a product of a preset coefficient and the inter-frame prediction cost, determine that a scene switch occurs; and a region update module 315 (not shown in FIG. 3) configured to, in response to the scene switch, interrupt a current ROI tracking process, use the current frame as a reference frame for a new scene, and re-execute an ROI establishment operation on the reference frame.

In some embodiments, the position prediction module 302 includes: a macroblock dividing submodule configured to divide a physical ROI of the reference frame into a macroblock set according to a standard macroblock size; a motion vector obtaining submodule configured to obtain motion vectors calculated for all macroblocks in the motion compensated temporal filter process; and a prediction generating submodule configured to use a motion vector aggregation algorithm to generate the ROI position prediction value of the current frame.

In some embodiments, the apparatus for encoding the video further includes: a confidence calculation module 316 (not shown in FIG. 3) configured to calculate consistency of motion vectors of all macroblocks within the physical ROI of the reference frame as a confidence score; a local occlusion determining module 317 (not shown in FIG. 3) configured to, in response to the confidence score exceeding a preset occlusion determination threshold, determine that local occlusion occurs in a corresponding macroblock region; and a position information update module 318 (not shown in FIG. 3) configured to, for the macroblock region with local occlusion, use a feature point matching method to update position information of the macroblock region in the current frame.

In some embodiments, the position correction module 303 includes: an expected position estimation submodule configured to calculate expected position coordinates of all feature points in the current frame according to the spatial topological relationship of feature points recorded in the initial ROI in combination with the ROI position prediction value; an actual position obtaining submodule configured to obtain actual position coordinates of corresponding feature points in the current frame by a facial feature point detection algorithm; a transformation parameter calculation submodule configured to calculate a spatial transformation parameter based on a correspondence between expected position coordinates and actual position coordinates; and a position prediction correction submodule configured to apply the spatial transformation parameter to correct the ROI position prediction value.

In some embodiments, the bitrate allocation module 305 includes: a main face bitrate allocation submodule configured to, in response to detecting that the real-time network bandwidth is not lower than a preset bandwidth threshold, control a proportion of a bitrate allocated for the main face region to a total bitrate to be not lower than a preset proportion threshold; and a background bitrate allocation submodule configured to, in response to detecting that the real-time network bandwidth is lower than the preset bandwidth threshold, ensure that the bitrate of the main face region is not lower than a preset minimum guaranteed bitrate, and compress the bitrate of the background region to be within a first compression coefficient range of an original baseline value.

In some embodiments, the apparatus for encoding the video further includes: a background bitrate dynamic adjustment module 319 (not shown in FIG. 3) configured to, when the bandwidth is insufficient for first trigger, compress the bitrate of the background region to a specific value within the first compression coefficient range; if the bandwidth continues to decrease and a decrease per unit time exceeds a preset rate threshold, compress the bitrate of the secondary face region to be within a second compression coefficient range; and a main face bitrate dynamic adjustment module 321 (not shown in FIG. 3) configured to ensure that the bitrate of the main face region is not lower than a protection redundancy coefficient multiple of the preset minimum guaranteed bitrate during compression.

In some embodiments, the parameter configuration module 304 includes: a first combination submodule configured to set a lowest quantization parameter offset value for the main face region so that a quantization parameter of the main face region is lower than a base quantization parameter of an encoder, enable a first prediction mode combination, and allocate an encoding resource with highest priority; a second combination submodule configured to set a moderate quantization parameter offset value for the secondary face region so that a quantization parameter of the secondary face region is equal to or slightly higher than the base quantization parameter of the encoder, enable a second prediction mode combination, and allocate an encoding resource with regular priority; and a third combination submodule configured to set a highest quantization parameter offset value for the background region, enable a third prediction mode combination, and allocate an encoding resource with lowest priority.

For the description of specific functions and examples of the modules and sub-modules of the apparatus of the embodiment of the present disclosure, reference may be made to the relevant description of the corresponding steps in the above-mentioned method embodiments, and details are not repeated here.

The apparatus for encoding the video in the embodiment of the present disclosure avoids independent motion estimation calculations by reusing the motion vector generated in the MCTF process; predicts the ROI of the current frame based on the physical ROI position of the reference frame to ensure real-time tracking; extracts facial feature points and establishes the spatial topological relationship in the first frame, and reuses the topological relationship to correct the predicted ROI position in subsequent frames, to maintain the cross-frame consistency. The differentiated quantization parameters are configured for different regions; priority is given to ensuring the quality of key regions in combination with the dynamic bitrate allocation strategy; and the ROI-level metadata is output at the encoding end. By outputting the encoded frame and metadata, the decoding end can be supported to optimize the display, facilitating the decoder to implement regionalized post-processing according to the metadata (e.g., sharpening the main face) to restore the display quality of key regions. Thus, the clarity of the main face can be improved while reducing the encoding delay, and the stuttering rate is significantly reduced when the bandwidth fluctuates, achieving real-time live streaming push with high definition and low bitrate.

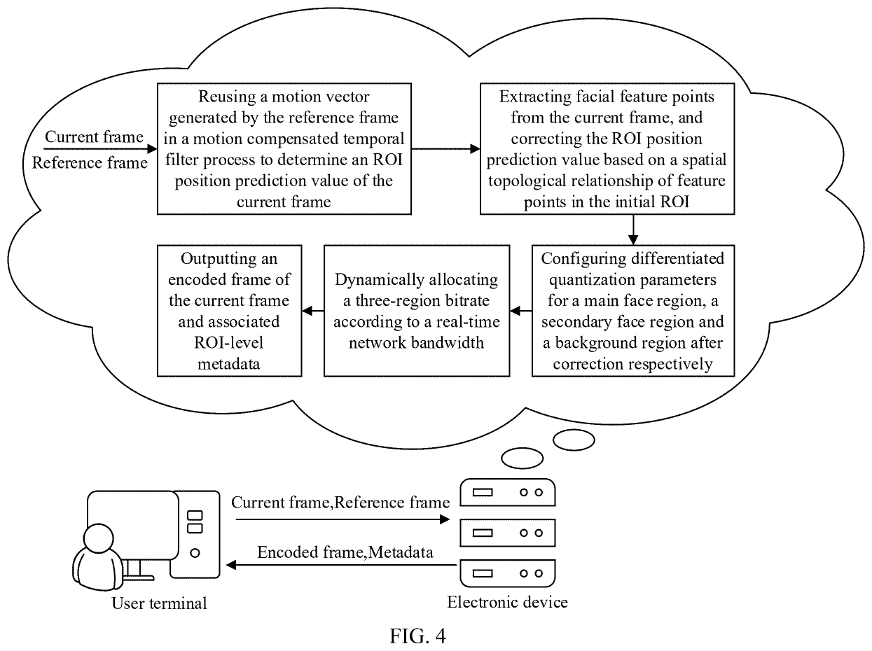

An embodiment of the present disclosure provides a schematic diagram of an scenario of the method for encoding the video, as shown in FIG. 4.

As mentioned above, the method for encoding the video according to the embodiment of the present disclosure is applied to an electronic device. The electronic device is intended to represent various forms of digital computers, such as a laptop, a desktop, a workstation, a personal digital assistant, a server, a blade server, a mainframe computer, and other suitable computers. Specifically, the electronic device may perform the following operations:

obtaining a reference frame that is adjacent to a current frame and has established hierarchical division of an initial ROI; reusing a motion vector generated by the reference frame in a motion compensated temporal filter process to determine an ROI position prediction value of the current frame; extracting facial feature points from the current frame, and correcting the ROI position prediction value based on a spatial topological relationship of feature points in the initial ROI; configuring differentiated quantization parameters for a main face region, a secondary face region and a background region after correction respectively; dynamically allocating a three-region bitrate according to a real-time network bandwidth; and outputting an encoded frame of the current frame and associated ROI-level metadata; where the ROI-level metadata includes: boundary coordinates of the main face region, the secondary face region and the background region; offset values of quantization parameters corresponding to all regions; and bitrate allocation weight values of all regions.

It should be understood that the scenario diagram shown in FIG. 4 is only illustrative and not restrictive, those skilled in the art can make various obvious changes and/or replacements based on the example of FIG. 4, and the obtained technical solutions still belong to the disclosure scope of the embodiments of the present disclosure.

In the technical solution of the present disclosure, the acquisition, storage and application of the user's personal information involved are in compliance with relevant laws and regulations, and do not violate public order and good customs.

According to the embodiments of the present disclosure, the present disclosure also provides an electronic device, a readable storage medium and a computer program product.

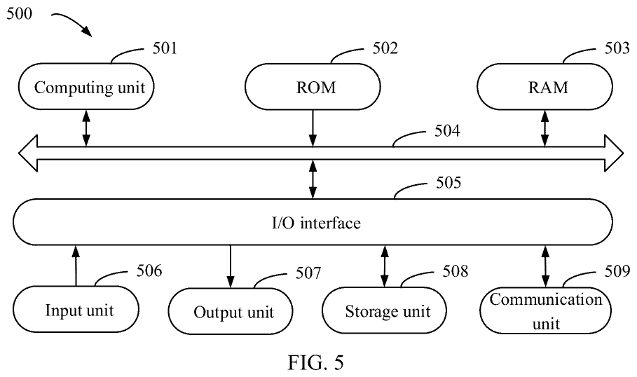

FIG. 5 shows a schematic block diagram of an exemplary electronic device 500 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 5, the device 500 includes a computing unit 501 that may perform various appropriate actions and processes according to a computer program stored in a Read-Only Memory (ROM) 502 or a computer program loaded from a storage unit 508 into a Random Access Memory (RAM) 503. Various programs and data required for operations of the device 500 may also be stored in the RAM 503. The computing unit 501, the ROM 502 and the RAM 503 are connected to each other through a bus 504. The Input/Output (I/O) interface 505 is also connected to the bus 504.

A plurality of components in the device 500 are connected to the I/O interface 505, and include an input unit 506 such as a keyboard, a mouse, or the like; an output unit 507 such as various types of displays, speakers, or the like; the storage unit 508 such as a magnetic disk, an optical disk, or the like; and a communication unit 509 such as a network card, a modem, a wireless communication transceiver, or the like. The communication unit 509 allows the device 500 to exchange information/data with other devices through a computer network such as the Internet and/or various telecommunication networks.

The computing unit 501 may be various general-purpose and/or special-purpose processing components with processing and computing capabilities. Some examples of the computing unit 501 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 501 performs various methods and processes described above, such as the method for encoding the video. For example, in some implementations, the method for encoding the video may be implemented as a computer software program tangibly contained in a computer-readable medium, such as the storage unit 508. In some implementations, a part or all of the computer program may be loaded and/or installed on the device 500 via the ROM 502 and/or the communication unit 509. When the computer program is loaded into the RAM 503 and executed by the computing unit 501, one or more steps of the method for encoding the video described above may be performed. Alternatively, in other implementations, the computing unit 501 may be configured to perform the method for encoding the video by any other suitable means (e.g., by means of firmware).

Various implementations of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System On Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include an electrical connection based on one or more lines, a portable computer disk, a hard disk, a random-access memory, a read-only memory, an Erasable Programmable Read-Only Memory (EPROM), a flash memory, an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display device (e.g., a Cathode Ray Tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A method for encoding a video, comprising:
obtaining a reference frame that is adjacent to a current frame and has established hierarchical division of an initial Region of Interest (ROI);
reusing a motion vector generated by the reference frame in a motion compensated temporal filter process to determine an ROI position prediction value of the current frame;
extracting facial feature points from the current frame, and correcting the ROI position prediction value based on a spatial topological relationship of feature points in the initial ROI;
configuring differentiated quantization parameters for a main face region, a secondary face region and a background region after correction respectively;
dynamically allocating a three-region bitrate according to a real-time network bandwidth; and
outputting an encoded frame of the current frame and associated ROI-level metadata; wherein the ROI-level metadata comprises: boundary coordinates of the main face region, the secondary face region and the background region; offset values of quantization parameters corresponding to all regions; and bitrate allocation weight values of all regions.

2. The method of claim 1, wherein establishing the initial ROI comprises:
using a lightweight face detection algorithm for a first frame of the video to locate a face region; and
partitioning the face region according to facial key points into three regions: the main face region, the secondary face region and the background region, wherein the main face region comprises a minimum rectangular region covering eyebrows, eyes, nose and mouth; the secondary face region comprises a ring-shaped region covering cheeks and chin; and the background region comprises a remaining region of the face.

3. The method of claim 2, further comprising:
for a plurality of face regions detected in the first frame, calculating a central region weight and an area weight of each face, wherein the central region weight reflects a proximity of a face center position to an image center, and the area weight reflects a proportion of a face region to a total image area;
calculating a comprehensive score of each face according to a preset central weight factor and a preset area weight factor;
selecting a face with a highest comprehensive score as a main tracking target, and determining a face region of the main tracking target as the main face region; and
merging remaining face regions that are not selected as the main tracking target into the secondary face region.

4. The method of claim 1, further comprising:
obtaining intra-frame prediction cost and inter-frame prediction cost of the current frame;
in response to the intra-frame prediction cost not exceeding a product of a preset coefficient and the inter-frame prediction cost, determining that a scene switch occurs; and
in response to the scene switch, interrupting a current ROI tracking process, using the current frame as a reference frame for a new scene, and re-executing an ROI establishment operation on the reference frame.

5. The method of claim 1, wherein reusing the motion vector generated by the reference frame in the motion compensated temporal filter process to determine the ROI position prediction value of the current frame, comprises:
dividing a physical ROI of the reference frame into a macroblock set according to a standard macroblock size;
obtaining motion vectors calculated for all macroblocks in the motion compensated temporal filter process; and
using a motion vector aggregation algorithm to generate the ROI position prediction value of the current frame.

6. The method of claim 5, further comprising:
calculating consistency of motion vectors of all macroblocks within the physical ROI of the reference frame as a confidence score;
in response to the confidence score exceeding a preset occlusion determination threshold, determining that local occlusion occurs in a corresponding macroblock region; and
for the macroblock region with local occlusion, using a feature point matching method to update position information of the macroblock region in the current frame.

7. The method of claim 1, wherein correcting the ROI position prediction value based on the spatial topological relationship of feature points in the initial ROI, comprises:
calculating expected position coordinates of all feature points in the current frame according to the spatial topological relationship of feature points recorded in the initial ROI in combination with the ROI position prediction value;
obtaining actual position coordinates of corresponding feature points in the current frame by a facial feature point detection algorithm;
calculating a spatial transformation parameter based on a correspondence between expected position coordinates and actual position coordinates; and
applying the spatial transformation parameter to correct the ROI position prediction value.

8. The method of claim 1, wherein dynamically allocating the three-region bitrate according to the real-time network bandwidth, comprises:
in response to detecting that the real-time network bandwidth is not lower than a preset bandwidth threshold, controlling a proportion of a bitrate allocated for the main face region to a total bitrate to be not lower than a preset proportion threshold; and
in response to detecting that the real-time network bandwidth is lower than the preset bandwidth threshold, ensuring that the bitrate of the main face region is not lower than a preset minimum guaranteed bitrate, and compressing the bitrate of the background region to be within a first compression coefficient range of an original baseline value.

9. The method of claim 8, further comprising:
when the bandwidth is insufficient for first trigger, compressing the bitrate of the background region to a specific value within the first compression coefficient range;
if the bandwidth continues to decrease and a decrease per unit time exceeds a preset rate threshold, compressing the bitrate of the secondary face region to be within a second compression coefficient range; and
ensuring that the bitrate of the main face region is not lower than a protection redundancy coefficient multiple of the preset minimum guaranteed bitrate during compression.

10. The method of claim 1, wherein configuring the differentiated quantization parameters for the main face region, the secondary face region and the background region after correction respectively, comprises:
setting a lowest quantization parameter offset value for the main face region so that a quantization parameter of the main face region is lower than a base quantization parameter of an encoder, enabling a first prediction mode combination, and allocating an encoding resource with highest priority;
setting a moderate quantization parameter offset value for the secondary face region so that a quantization parameter of the secondary face region is equal to or slightly higher than the base quantization parameter of the encoder, enabling a second prediction mode combination, and allocating an encoding resource with regular priority; and
setting a highest quantization parameter offset value for the background region, enabling a third prediction mode combination, and allocating an encoding resource with lowest priority.

11. An electronic device, comprising:
at least one processor; and
a memory connected in communication with the at least one processor;
wherein the memory stores an instruction executable by the at least one processor, and the instruction is executed by the at least one processor to enable the at least one processor to execute:
obtaining a reference frame that is adjacent to a current frame and has established hierarchical division of an initial Region of Interest (ROI);
reusing a motion vector generated by the reference frame in a motion compensated temporal filter process to determine an ROI position prediction value of the current frame;
extracting facial feature points from the current frame, and correcting the ROI position prediction value based on a spatial topological relationship of feature points in the initial ROI;
configuring differentiated quantization parameters for a main face region, a secondary face region and a background region after correction respectively;
dynamically allocating a three-region bitrate according to a real-time network bandwidth; and
outputting an encoded frame of the current frame and associated ROI-level metadata; wherein the ROI-level metadata comprises: boundary coordinates of the main face region, the secondary face region and the background region; offset values of quantization parameters corresponding to all regions; and bitrate allocation weight values of all regions.

12. The electronic device of claim 11, wherein the instruction is executed by the at least one processor to enable the at least one processor to execute establishing the initial ROI, by:
using a lightweight face detection algorithm for a first frame of the video to locate a face region; and
partitioning the face region according to facial key points into three regions: the main face region, the secondary face region and the background region, wherein the main face region comprises a minimum rectangular region covering eyebrows, eyes, nose and mouth; the secondary face region comprises a ring-shaped region covering cheeks and chin; and the background region comprises a remaining region of the face.

13. The electronic device of claim 12, wherein the instruction is executed by the at least one processor to enable the at least one processor to further execute:
for a plurality of face regions detected in the first frame, calculating a central region weight and an area weight of each face, wherein the central region weight reflects a proximity of a face center position to an image center, and the area weight reflects a proportion of a face region to a total image area;
calculating a comprehensive score of each face according to a preset central weight factor and a preset area weight factor;
selecting a face with a highest comprehensive score as a main tracking target, and determining a face region of the main tracking target as the main face region; and
merging remaining face regions that are not selected as the main tracking target into the secondary face region.

14. The electronic device of claim 11, wherein the instruction is executed by the at least one processor to enable the at least one processor to further execute:
obtaining intra-frame prediction cost and inter-frame prediction cost of the current frame;
in response to the intra-frame prediction cost not exceeding a product of a preset coefficient and the inter-frame prediction cost, determining that a scene switch occurs; and
in response to the scene switch, interrupting a current ROI tracking process, using the current frame as a reference frame for a new scene, and re-executing an ROI establishment operation on the reference frame.

15. The electronic device of claim 11, wherein the instruction is executed by the at least one processor to enable the at least one processor to execute reusing the motion vector generated by the reference frame in the motion compensated temporal filter process to determine the ROI position prediction value of the current frame, by:
dividing a physical ROI of the reference frame into a macroblock set according to a standard macroblock size;
obtaining motion vectors calculated for all macroblocks in the motion compensated temporal filter process; and
using a motion vector aggregation algorithm to generate the ROI position prediction value of the current frame.

16. A non-transitory computer-readable storage medium storing a computer instruction thereon, wherein the computer instruction is used to cause a computer to execute:
obtaining a reference frame that is adjacent to a current frame and has established hierarchical division of an initial Region of Interest (ROI);
reusing a motion vector generated by the reference frame in a motion compensated temporal filter process to determine an ROI position prediction value of the current frame;
extracting facial feature points from the current frame, and correcting the ROI position prediction value based on a spatial topological relationship of feature points in the initial ROI;
configuring differentiated quantization parameters for a main face region, a secondary face region and a background region after correction respectively;
dynamically allocating a three-region bitrate according to a real-time network bandwidth; and
outputting an encoded frame of the current frame and associated ROI-level metadata; wherein the ROI-level metadata comprises: boundary coordinates of the main face region, the secondary face region and the background region; offset values of quantization parameters corresponding to all regions; and bitrate allocation weight values of all regions.

17. The non-transitory computer-readable storage medium of claim 16, wherein the computer instruction is used to cause the computer to execute establishing the initial ROI, by:
using a lightweight face detection algorithm for a first frame of the video to locate a face region; and
partitioning the face region according to facial key points into three regions: the main face region, the secondary face region and the background region, wherein the main face region comprises a minimum rectangular region covering eyebrows, eyes, nose and mouth; the secondary face region comprises a ring-shaped region covering cheeks and chin; and the background region comprises a remaining region of the face.

18. The non-transitory computer-readable storage medium of claim 17, wherein the computer instruction is used to cause the computer to further execute:
for a plurality of face regions detected in the first frame, calculating a central region weight and an area weight of each face, wherein the central region weight reflects a proximity of a face center position to an image center, and the area weight reflects a proportion of a face region to a total image area;
calculating a comprehensive score of each face according to a preset central weight factor and a preset area weight factor;
selecting a face with a highest comprehensive score as a main tracking target, and determining a face region of the main tracking target as the main face region; and
merging remaining face regions that are not selected as the main tracking target into the secondary face region.

19. The non-transitory computer-readable storage medium of claim 16, wherein the computer instruction is used to cause the computer to further execute:
obtaining intra-frame prediction cost and inter-frame prediction cost of the current frame;
in response to the intra-frame prediction cost not exceeding a product of a preset coefficient and the inter-frame prediction cost, determining that a scene switch occurs; and
in response to the scene switch, interrupting a current ROI tracking process, using the current frame as a reference frame for a new scene, and re-executing an ROI establishment operation on the reference frame.

20. The non-transitory computer-readable storage medium of claim 16, wherein the computer instruction is used to cause the computer to execute reusing the motion vector generated by the reference frame in the motion compensated temporal filter process to determine the ROI position prediction value of the current frame, by:
dividing a physical ROI of the reference frame into a macroblock set according to a standard macroblock size;
obtaining motion vectors calculated for all macroblocks in the motion compensated temporal filter process; and
using a motion vector aggregation algorithm to generate the ROI position prediction value of the current frame.
